(19) United States
(12) Patent Application Publication
(10) Pub. No.: US 2017/0182366 A1
(43) Pub. Date: Jun. 29, 2017

(54) GOLF BALL AND RESIN COMPOSITION FOR COVER OR TOPCOAT THEREOF

(71) Applicant: BRIDGESTONE SPORTS CO., LTD., Tokyo (JP)

(72) Inventors: Hirotaka SHINOHARA, Chichibu-shi (JP); Takashi OHIRA, Chichibu-shi (JP); Ryoto TAKAHASHI, Seki-shi (JP)

(73) Assignee: BRIDGESTONE SPORTS CO., LTD., Tokyo (JP)

(21) Appl. No.: 15/387,811

(22) Filed: Dec. 22, 2016

(30) Foreign Application Priority Data
Dec. 25, 2015 (JP) 2015-253304

(51) Int. Cl. A63B 37/00; C09D 5/22; C09D 133/14; C09D 5/32

(52) U.S. Cl. CPC A63B 37/0022; A63B 37/0074; C09D 5/32; C09D 5/22; C09D 133/14

(57) ABSTRACT

A resin composition for a cover or topcoat of golf balls includes: a resin for a cover or topcoat of a golf ball; an ultraviolet (UV) absorber for absorbing UV rays, of which an absorbance spectrum has an absorption peak at a wavelength in a range of 310 nm to 330 nm, has an absorbance in a wavelength range of 300 nm to 350 nm of at least 1.0 AU and has an absorbance at a wavelength of 370 nm of 0.1 to 0.5 AU; and a fluorescent whitening agent for absorbing UV rays and emitting visible rays, of which an absorbance spectrum has an absorption peak at a wavelength in a range of 350 nm to 370 nm, wherein a concentration of the UV absorber ranges from 0.25 to 1.5% by mass with respect to a total mass of the resin composition.

### CROSS-REFERENCE TO RELATED APPLICATION

This application claims priority from Japanese Patent Application No. 2015-253304 filed Dec. 25, 2015, which is incorporated herein by reference in its entirety.

### BACKGROUND OF THE INVENTION

The present invention relates to a golf ball and to a resin composition for a cover or for a topcoat thereof.

Various golf balls have been marketed, such as golf balls with colorful appearance or color patterns, but, in general, common golf balls have a white background surface on which the name of the manufacturer, brand name, logo, or symbol such as number or letter is provided. White golf balls are usually produced by forming a cover with dimples by using a resin containing white pigments, and then forming a colorless transparent topcoat on the surface of the cover.

The resin for the cover mentioned above may be easily yellowed when exposed to sunlight. To prevent such yellowing, the cover or the topcoat may contain an ultraviolet (UV) absorber for absorbing UV rays in sunlight, or may contain a fluorescent whitening agent for absorbing UV rays and emitting visible rays having predetermined wavelengths to make the color look more distinctively white. JP 2000-516521 A discloses a UV-resistant urethane top coat for golf balls including: a predetermined amount of a UV absorber, of which an absorbance spectrum has an absorption peak at a wavelength in a range of about 330 nm to about 360 nm and has the UV light absorbance at a wavelength of about 350 nm that is at least about 3 times greater than the UV light absorbance at a wavelength of about 370 nm; and a predetermined amount of a fluorescent whitening agent that which absorbs ultraviolet rays at wavelengths greater than about 350 nm and emits visible rays.

In addition, JP 08-318186 A discloses a method for measuring a thickness of a coating film on the surface of a golf ball by using a fluorescent whitening agent included in the film, in which a charge-coupled device (CCD) camera detects secondary emission rays, which are emitted from the golf ball by being irradiated with UV rays, and then obtains a contrast image of the film by image-processing to determine the film thickness based on the obtained contrast.

### SUMMARY OF INVENTION

As disclosed by JP 2000-516521 A, the cover or the topcoat of golf balls contains a UV absorber to prevent yellowing of golf balls, but this technique may raise a problem in that the measurement of film thickness using visible rays emitted from fluorescent whitening agents, which is disclosed in JP 08-318186 A, cannot be correctly performed, probably due to influence from some combination of a UV absorber and a fluorescent whitening agent, which absorb different wavelength ranges of UV rays.

To solve the problem discussed above, an object of the present invention is to provide a golf ball of which yellowing can be prevented when exposed to sunlight and which enables to measure a thickness of a cover or topcoat with a high accuracy in a film thickness measurement test by utilizing a fluorescent whitening agent in the cover or topcoat, and to provide a resin composition for a cover or topcoat of the golf ball.

In order to achieve the object mentioned above, according to an aspect of the present invention, a resin composition for a cover or topcoat of golf balls includes: a resin for a cover or topcoat of a golf ball; an ultraviolet (UV) absorber for absorbing UV rays, of which an absorbance spectrum has an absorption peak at a wavelength in a range of 310 nm to 330 nm, has an absorbance in a wavelength range of 300 nm to 350 nm of at least 1.0 AU and has an absorbance at a wavelength of 370 nm of 0.1 to 0.5 AU; and a fluorescent whitening agent for absorbing UV rays and emitting visible rays, of which an absorbance spectrum has an absorption peak at a wavelength in a range of 350 nm to 370 nm, wherein a concentration of the UV absorber ranges from 0.25 to 1.5% by mass with respect to a total mass of the resin composition.

In the absorption spectrum of the UV absorber, an area obtained by integrating absorbance over a wavelength range from 290 nm to 320 nm may be substantially equal to an area obtained by integrating absorbance over a wavelength range from 320 nm to 350 nm. The area may be twice as large as an area obtained by integrating absorbance over a wavelength range from 350 nm to 390 nm. The concentration of the UV absorber may range from 0.4 to 0.5% by mass with respect to the total mass of the resin composition.

The resin composition may have a luminance characteristic satisfying the following expression:

LU20−LU5≧20 cd/m²

where LU5 denotes a luminance obtained by irradiating a film having a thickness of 5 μm formed from the resin composition with UV rays having a luminous intensity of 140 lux, and LU20 denotes a luminance obtained by irradiating a film having a thickness of 20 μm formed from the resin composition with UV rays having a luminous intensity of 140 lux.

The resin composition may have a color difference ΔEh in a Lab color system between before and after a color tone change test of at most 2.5, the color tone change test being carried out by irradiating a film formed from the resin composition with a xenon lamp. The resin composition may have a change in yellowness index ΔYI between before and after a color tone change test of at most 10, the color tone change test being carried out by irradiating a film formed from the resin composition with a xenon lamp.

According to another aspect of the present invention, a resin composition for a cover or topcoat of golf balls includes: a resin for a cover or topcoat of a golf ball; an ultraviolet (UV) absorber for absorbing UV rays, of which an absorbance spectrum has an absorption peak at a wavelength in a range of 310 nm to 330 nm, has an absorbance in a wavelength range of 300 nm to 350 nm of at least 1.0 AU and has an absorbance at a wavelength of 370 nm of 0.1 to 0.5 AU; and a fluorescent whitening agent for absorbing UV rays and emits visible rays, of which an absorbance spectrum has an absorption peak at a wavelength range of 350 nm to 370 nm, wherein the resin composition has a luminance characteristic satisfying the following expression:

LU20−LU5≧20 cd/m²

where LU5 denotes a luminance obtained by irradiating a film having a thickness of 5 μm formed from the resin composition with UV rays having a luminous intensity of 140 lux, and LU20 denotes a luminance obtained by irradiating a film having a thickness of 20 μm formed from the resin composition with UV rays having a luminous intensity of 140 lux, wherein the resin composition has a color difference ΔEh in a Lab color system between before and after a color tone change test of at most 2.5, the color tone change test being carried out by irradiating a film formed from the resin composition with a xenon lamp.

According to yet another aspect of the present invention, a golf ball includes a core, a cover, and a topcoat, wherein the cover or the topcoat comprises a UV absorber for absorbing UV rays and a fluorescent whitening agent for absorbing UV rays and emitting visible rays, wherein an absorbance spectrum of the UV absorber has an absorption peak at a wavelength in a range of 310 nm to 330 nm, has an absorbance in a wavelength range of 300 nm to 350 nm of at least 1.0 AU and has an absorbance at a wavelength of 370 nm of 0.1 to 0.5 AU, wherein an absorbance spectrum of the fluorescent whitening agent has an absorption peak at a wavelength in a range of 350 nm to 370 nm, and wherein a concentration of the UV absorber ranges from 0.25 to 1.5% by mass with respect to a total mass of the cover or the topcoat.

As discussed above, according to the present invention, adding a predetermined UV absorber and a predetermined fluorescent whitening agent to a cover or topcoat and controlling the concentration of the UV absorber within 0.25 to 1.5% by mass can prevent yellowing of the golf ball when exposed to sunlight and can measure a thickness of the cover or topcoat with a high accuracy in a film thickness measurement test by utilizing the fluorescent whitening agent without any influence of the UV absorber.

### BRIEF DESCRIPTION OF DRAWINGS

FIG. 1 is a graph showing the absorption spectra in terms of a UV wave range of UV absorbers.

FIG. 2 is a graph showing the absorption spectrum in terms of a UV wave range of a fluorescent whitening agent.

FIG. 3 is a photograph showing a film thickness measuring apparatus for a golf ball used in the present invention.

### DESCRIPTION OF EMBODIMENTS

Embodiments of a golf ball and a resin composition for a cover or topcoat of golf balls according to the present invention will be described in detail below with reference to the accompanying drawings.

The resin composition for a cover or topcoat according to the present embodiment includes a resin for a cover or topcoat of golf ball, a UV absorber for absorbing UV rays, and a fluorescent whitening agent which absorbs UV rays and emits visible rays, as main components.

The resin for cover may be formed by using ionomer resins, polyurethane thermoplastic elastomers, thermosetting polyurethanes, or a mixture thereof as the main component, but the present invention is not limited thereto. In addition to the main components, other thermoplastic elastomers, polyisocyanate compounds, fatty oil or derivatives thereof, basic inorganic metal compounds, fillers, and the like can be added to the resin for cover.

The ionomer resin may include, but is not limited to, a base resin containing the following component (a) and/or component (b). Moreover, the following component (c) can be optionally added to the base resin. The component (a) is an olefin-unsaturated carboxylic acid-unsaturated carboxylic ester random terpolymer and/or metal salts thereof. The component (b) is an olefin-unsaturated carboxylic acid random bipolymer and/or metal salts thereof. The component (c) is a thermoplastic block copolymer including a polyolefin crystal block and a polyethylene/butylene random copolymer.

The resin for topcoat may include, but is not limited to, two-component type curable resins including polyols such as acrylic polyols and polyester polyols as the base resin, and isocyanates such as hexamethylene diisocyanate (HDI), tolylene diisocyanate (TDI), isophorone diisocyanate (IPDI), diphenylmethane diisocyanate (MDI), and the like as the curing agent. In addition to the above components, the base resin may include solvents such as ethyl acetate, butyl acetate, propylene glycol monomethyl ether acetate, methyl ethyl ketone, and methyl isobutyl ketone. In addition, the base resin may include a curing catalyst to promote curing.

For the UV absorber, a UV absorber is used of which an absorbance spectrum has an absorption peak at a wavelength in a range of 310 nm to 330 nm, has an absorbance in the wavelength range of 330 nm to 350 nm of at least 1.0 AU and has an absorbance at a wavelength of 370 nm of 0.1 to 0.5 AU. Because the UV absorber having such absorption spectrum is used, UV rays can be effectively absorbed with a small content of UV absorber. The absorption peak preferably presents at a wavelength ranging from 315 nm to 325 nm. In addition, the absorbance at a wavelength of 370 nm is preferably in a range of 0.2 to 0.4 AU. An upper limit of the absorbance in a wavelength range of 300 nm to 350 nm is, but is not limited to, preferably 2.5 AU. Moreover, the absorbance in a wavelength range of 310 nm to 340 nm is preferably 1.5 AU or more. An upper limit of the absorbance in a wavelength range of 310 nm to 340 nm is, but is not limited to, preferably 2.5 AU or less.

The UV absorber preferably have an absorption spectrum for which an area obtained by integrating the absorbance of a wavelength range of 320 nm to 290 nm and an area obtained by integrating the absorbance of a wavelength range of 320 nm to 350 nm are the same. In addition, the UV absorber preferably has an absorption spectrum for which the above-described area is twice as large as an area obtained by integrating the absorbance of a wavelength range of 350 to 390 nm or larger.

Examples of the UV absorber having such an absorption spectrum may include salicylic acid derivatives and benzophenone UV absorbers, benzotriazole UV absorbers, cyanoacrylate UV absorbers, and triazine UV absorbers. These UV absorbers can be used alone or in combination thereof. Among them, the triazine UV absorber is particularly preferable, and a hydroxyphenyltriazine UV absorber is more particularly preferable.

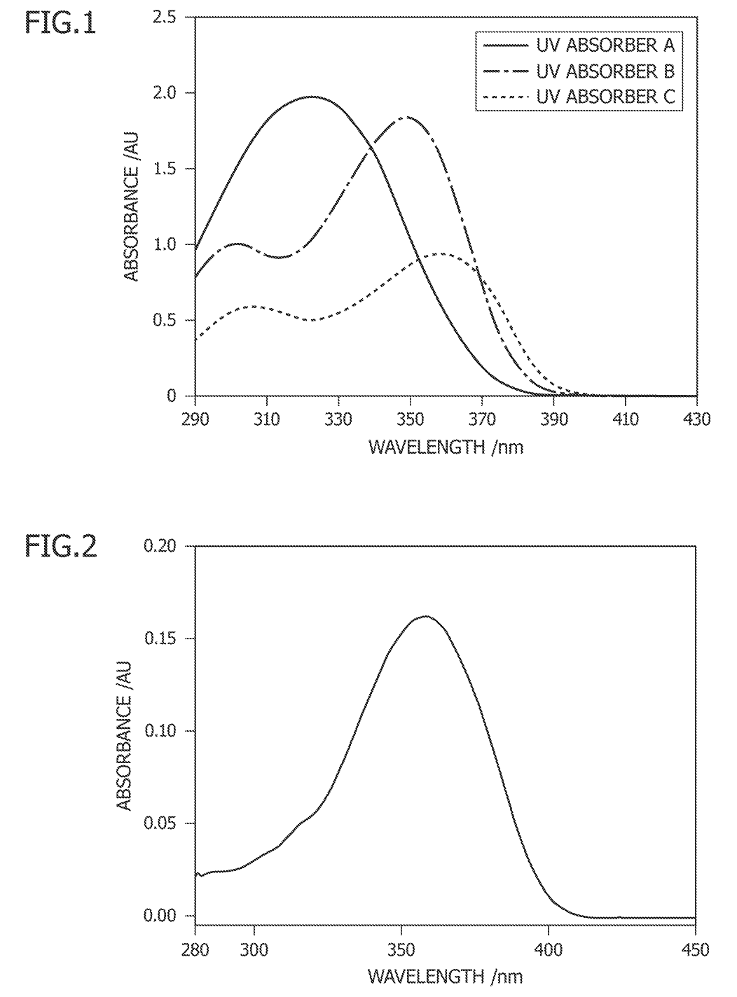

Specifically, 2-(2-hydroxy-4-[1-octyloxycarbonylethoxy]phenyl)-4,6-bis(4-phenylphenyl)-1,3,5-triazine is preferable, which is available as a commercial product “Tinuvin 479” (from BASF Coatings AG.), for example. The absorption spectrum of Tinuvin 479 is shown in FIG. 1 as the UV absorber A. Referring to FIG. 1, the absorption spectra greatly differ according to the type of the UV absorber. Note that AU on the ordinate axis of FIG. 1 and AU recited in Claims of the present invention can be calculated by the following expression.

AU=log(I₀/I)=εCL

where I₀ is intensity of incident light, I is intensity of transmitted light, ε is an absorbance index, C is the concentration of 20 mg/l of a UV absorber diluted with a toluene solution, and L is the cell length of 1 cm.

The concentration of the UV absorber is within a range of 0.25 to 1.5% by mass with respect to the total mass of the resin composition. Because the concentration is controlled within this range, the film thickness measured by using a fluorescent whitening agent can be performed with a high accuracy without any adverse affect from the UV absorber. The concentration of the UV absorber is preferably within a range of 0.4 to 1.0% by mass, more preferably 0.4 to 0.5% by mass.

For the fluorescent whitening agent, a fluorescent whitening agent having an absorption peak at a wavelength range of 350 nm to 370 nm. Examples of the fluorescent whitening agent having such an absorption spectrum includes cumarin fluorescent whitening agents, oxazinone fluorescent whitening agents, stilbene fluorescent whitening agents, naphthalin fluorescent whitening agents, and polyazoline fluorescent whitening agents. These fluorescent whitening agents can be used alone or in combination thereof. Among them, the cumarin fluorescent whitening agent is particularly preferable. The fluorescent whitening agent is available as a commercial product “PY1800” (a product of Hakko Chemical Co., Ltd.). The absorption spectrum of PY1800 is shown in FIG. 2.

The concentration of the fluorescent whitening agent is preferably in a range of 0.01 to 1.0% by mass with respect to the total mass of the resin composition, and more preferably 0.05 to 0.50% by mass.

In addition to the above components, white pigments, pearl pigments, and the like can be added to the resin composition for the cover or the topcoat.

Furthermore, the resin composition according to the present invention preferably has the following physical properties.

The resin composition according to the present invention preferably has a luminance characteristic which satisfies the following expression:

LU20−LU5≧20 cd/m²

where LU5 is luminance obtained when a film with a thickness of 5 μm is formed by using the resin composition and the film is irradiated with UV rays having a luminous intensity of 140 lux, and LU20 is luminance obtained when a film with a thickness of 20 μm is formed by using the resin composition and the film is irradiated with UV rays having a luminous intensity of 140 lux. Because the resin composition according to the present invention has the above-described luminance characteristic, the present invention is useful in the point that the film thickness can be measured by using the above-described fluorescent whitening agent with high accuracy. Measurement of the luminance LU20 and LU5 will be described in detail below. The value for the term “LU20−LU5” is preferably 40 cd/m² or more. The value for the term “LU20−LU5” is not particularly limited by an upper limit.

In the resin composition according to the present invention, a color difference ΔEh in the Lab color system is preferably 5.0 or less in a color tone change test in which a film formed from the resin composition is irradiated with a xenon lamp. The color difference ΔEh in the Lab color system is measured in conformity with Japanese Industrial Standards (JIS) Z 8730-1980. Because the color difference ΔEh is controlled to be 5.0 or less, color tone changes that may occur due to exposure to sunlight can be remarkably suppressed. The color difference ΔEh is more preferably 2.5 or less.

In the resin composition according to the present invention, a change in yellowness index ΔYI is preferably 10 or less in a color tone change test in which a film formed from the resin composition is irradiated with a xenon lamp. The change in yellowness index ΔYI is measured in conformity with JIS K 7373. Because the above-described change in yellowness index ΔYI is controlled to be 10 or less, yellowing that may occur due to exposure to sunlight can be remarkably suppressed. The change in yellowness index ΔYI is more preferably 8 or less, yet more preferably 6 or less. A lower limit of the change in yellowness index ΔYI is not particularly limited.

Next, an embodiment of a method of producing a golf ball by using the resin composition for the cover or the topcoat will be described.

The golf ball according to the present invention can employ a multi-piece structure such as a two-piece structure constituted by a core and a cover and a three-piece structure constituted by a core, a cover, and an intermediate layer provided between the core and the cover. The core can be formed primarily from base material rubber. For the base material rubber, a wide variety of rubbers can be employed. Examples of the rubber that can be used include, but is not limited to, polybutadiene rubber (BR), styrene-butadiene rubber (SBR), natural rubber (NR), polyisoprene rubber (IR), polyurethane rubber (PU), and silicone rubber.

In addition to the base material rubber that is the main component, optional components such as co-crosslinking agent, crosslinking agent, filler, age resistor, isomerization agent, peptizer, sulfur, and organosulfur compound can be added to the core. As the main component, instead of the base material rubber, a thermoplastic elastomer, an ionomer resin, or a mixture of them can be used.

The core may be a solid core or a hollow core, and has a substantially spherical shape. The outer diameter of the core is preferably in a range of 5 to 42 mm, more preferably in a range of 25 to 40 mm, which changes according to whether an intermediate layer is to be provided. If an intermediate is arranged between the core and the cover, an intermediate layer having a core-like function may be arranged, and alternatively, an intermediate layer having a cover-like function may be arranged. For a method of molding the core, known golf ball core molding methods can be used.

Next, a cover is formed on an outer circumference of the core by using the resin composition for the cover according to the present invention. Note that if the resin composition for the topcoat according to the present invention is used, a cover resin containing neither a UV absorber nor a fluorescent whitening agent is used for the cover. For a method of forming the cover, known golf ball cover molding methods can be used. The cover forming method is not particularly limited, and examples of the cover forming method include a method in which the core is placed inside molds and a resin composition for the cover is molded by injection molding, and the cover can be formed so that it covers the core. The molds for molding the cover has a plurality of protrusions for forming dimples on the surface of the cover. The thickness of the cover is not particularly limited by a lower limit or an upper limit, and a lower limit of the cover thickness is preferably 0.2 mm or more and more preferably 0.4 mm or more and an upper limit of the cover thickness is preferably 4 mm or less, more preferably 3 mm or less, and yet more preferably 2 mm or less.

Further, a topcoat is formed on the outer circumference of the cover by using the resin composition for the topcoat according to the present invention. Note that if the resin composition for the cover according to the present invention is used, a topcoat containing neither a UV absorber nor a fluorescent whitening agent is used. The thickness of the topcoat is not particularly limited by a lower limit or an upper limit, and a lower limit of the topcoat thickness is preferably 5 μm or more, more preferably 10 μm or more, and an upper limit of the topcoat thickness is preferably 100 μm or less, more preferably 60 μm or less.

With the above-described configuration, the golf ball including a cover or a topcoat containing a predetermined UV absorber and a predetermined fluorescent whitening agent can be obtained.

### Example

Now, examples of the present invention and comparative examples will be described below.

A topcoat for golf ball was formed by using the resin composition containing compounds shown in Table 1. The thickness of the topcoat was 15 μm. For a golf ball including this topcoat, a color tone test, a xenon color tone change test, and a film thickness measurement test were performed. In addition, for the resin composition, a thin film was separately prepared and a luminance test was performed.

### 1. Color Tone Test

The color tone test was performed by using a color difference meter (spectrum measuring apparatus “SC-P”, a product of Suga Test Instruments Co., Ltd.) and in conformity with JIS Z 8722 “Reflective Object Measurement Methods” (illumination with diffused light, an optical system in which the received light angle is 8°: condition c), and the color tone was measured by d/8 (measured by excluding a regular reflection component of the sample: with an optical trap). The diameter of the measurement hole was 30 mm. Moreover, according to the Lab color system under JIS Z 8701, values for L, a, and b and the yellowness YI were measured.

### 2. Xenon Color Tone Change Test

The xenon color tone change test was performed by using a Super Xenon Weather Meter (SX 75) of Suga Test Instruments Co., Ltd. The change of the color on the surface of the ball from the color before irradiation with xenon light to the color after the irradiation was measured by using a color difference meter (model name: SC-P) of Suga Test Instruments Co., Ltd. Then the susceptibility to discoloration against yellowing of the ball (ΔEh) was examined before and after the irradiation, based on the Lab color system under JIS Z 8701. Note that for the color difference ΔEh, the discoloration becomes less for smaller values. In addition, yellowing was evaluated based on the color difference ΔEh. For the evaluation criteria, the result was evaluated as “S” when the value of ΔEh was 2.5 or less, “A” when the value of ΔEh was 5.0 or less, and “B” when the value of ΔEh exceeded 5.0.

### 3. Film Thickness Measurement Test

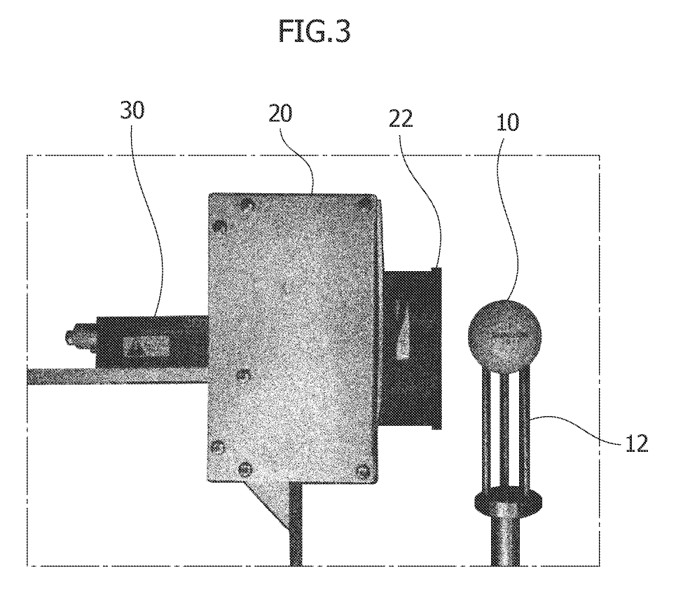

The film thickness measurement test was performed by using a film thickness measurement apparatus illustrated in FIG. 3. Specifically, a golf ball 10 was placed on a support 12, the golf ball 10 was irradiated with a UV ray emitted from a ring-like lighting unit 22 of a UV ray irradiation apparatus 20. Secondary emission rays from the golf ball 10 were photographed by using a CCD camera 30 via a hollow space of the ring-like lighting unit 22. Then predetermined image processing was performed to obtain a contrast image of the film, and the thickness of the film was measured based on the obtained contrast.

Note that for the film thickness measurement test, a film with a thickness of 5 μm was formed by using the resin composition prior to the test, UV rays with the luminous intensity of 140 lux and UV rays with the luminous intensity of 180 lux were irradiated onto the film, and the luminance LU5 was measured, and a film with a thickness of 20 μm was formed by using the resin composition prior to the test, UV rays with the luminous intensity of 140 lux and UV rays with the luminous intensity of 180 lux were irradiated onto the film, and the luminance LU20 was measured, to generate a calibration curve for the film thickness. The luminance measurement result was evaluated as “S” when the luminance was 40 or higher, “A” when the luminance was 20 or higher, and “B” when the luminance was 19 or lower.

TABLE 1

| | | Example | | | | | Comparative Example | | | |
|---|---|---|---|---|---|---|---|---|---|---|
| | | 1 | 2 | 3 | 4 | 5 | 1 | 2 | 3 | 4 |
| Base resin | Acrylic polyol | 20 | 20 | 20 | 20 | 20 | 20 | 20 | 20 | 20 |
| | Butyl acetate | 30 | 30 | 30 | 30 | 30 | 30 | 30 | 30 | 30 |
| | Propylene glycol | 20 | 20 | 20 | 20 | 20 | 20 | 20 | 20 | 20 |
| | monomethyl | | | | | | | | | |
| | ether acetate | | | | | | | | | |
| | Curing catalyst | 0.03 | 0.03 | 0.03 | 0.03 | 0.03 | 0.03 | 0.03 | 0.03 | 0.03 |
| | Ethyl acetate | 20 | 20 | 20 | 20 | 20 | 20 | 20 | 20 | 20 |
| Curing | Hexamethylene | 26.25 | 26.25 | 26.25 | 26.25 | 26.25 | 26.25 | 26.25 | 26.25 | 26.25 |
| agent | diisocyanate | | | | | | | | | |
| | Ethyl acetate | 23.75 | 23.75 | 23.75 | 23.75 | 23.75 | 23.75 | 23.75 | 23.75 | 23.75 |
| UV | Tinuvin 479 | 1.5 | 1.0 | 0.5 | 0.4 | 0.3 | 0.2 | 0.1 | 2.0 | 1.7 |
| absorber | | | | | | | | | | |
| Fluorescent | PY1800 | 0.15 | 0.15 | 0.15 | 0.15 | 0.15 | 0.15 | 0.15 | 0.15 | 0.15 |
| whitening | | | | | | | | | | |
| agent | | | | | | | | | | |

TABLE 2

| | | Example | | | | | Comparative Example | | | |
|---|---|---|---|---|---|---|---|---|---|---|
| | | 1 | 2 | 3 | 4 | 5 | 1 | 2 | 3 | 4 |
| Color tone | L | 88.3 | 88.52 | 88.46 | 86.26 | 88.31 | 86.3 | 86.16 | 88.26 | 88.28 |
| test | a | −2.48 | −2.22 | −2.75 | −2.56 | −2.45 | −2.43 | −2.45 | −3.03 | -2.72 |
| | b | −6.79 | −7.47 | −6.16 | −8.08 | −8.21 | −8.29 | −8.25 | 5.65 | 6.12 |
| | YI | −15.43 | −16.57 | −14.36 | −18.54 | −18.71 | −18.87 | −18.84 | −13.58 | -14.55 |
| Xenon color | ΔEh | 1.28 | 1.24 | 2.00 | 2.38 | 4.01 | 6.59 | 8.82 | 0.36 | 0.78 |
| tone change | ΔYI | 2.31 | 2.15 | 3.61 | 3.93 | 6.74 | 11.2 | 15.19 | 0.67 | 1.21 |
| test | | | | | | | | | | |
| Luminous | 5 μm | 97.9 | 119.8 | 142.3 | 159.9 | 177.4 | 181.4 | 185.8 | 83.5 | 92.3 |
| intensity of | 20 μm | 118.1 | 144.2 | 186.7 | 210.0 | 229.2 | 245.1 | 254.0 | 93.6 | 104.4 |
| 140 lux | | | | | | | | | | |
| Luminous | 5 μm | 130.5 | 160.4 | 191.7 | 218.3 | 238.8 | 243.3 | 248.4 | 110.4 | 122.2 |
| intensity of | 20 μm | 158.7 | 194.3 | 250.7 | 255.0 | 255.0 | 255.0 | 255.0 | 124.6 | 139.7 |
| 180 lux | | | | | | | | | | |

| | | | | | | | | | |
|---|---|---|---|---|---|---|---|---|---|
| Difference at Luminous | 20.2 | 24.4 | 44.4 | 50.1 | 51.8 | 63.7 | 68.2 | 10.1 | 12.1 |
| intensity of 140 lux | | | | | | | | | |
| Difference at Luminous | 28.2 | 33.9 | 59.0 | 36.7 | 16.2 | 11.7 | 6.6 | 14.2 | 17.5 |
| intensity of 180 lux | | | | | | | | | |
| Film thickness test | A | A | S | S | S | S | S | B | B |
| Yellowing | S | S | S | S | A | B | B | S | S |

As shown in Table 1 and Table 2, in Examples 1 to 5 in which the concentration of the UV absorber was in a range of 0.3 to 1.5% by mass, the thickness of the topcoat could be measured by the film thickness measurement test with a high accuracy, and in addition, substantially no yellowing occurred. On the other hand, in Comparative Examples 1 and 2 in which the concentration of the UV absorber was as low as 0.1 to 0.2% by mass, the thickness of the topcoat could be measured by the film thickness measurement test with a high accuracy, but considerable yellowing occurred. In Comparative Examples 4 and 5 in which the concentration of the UV absorber was as high as 1.7 to 2.0% by mass, substantially no yellowing occurred, but the thickness of the topcoat could not be correctly measured by the film thickness measurement test.

For the value of the term “LU20−LU5”, in Examples 1 to 5, values ranging from 20.2 to 51.8 were obtained at the luminous intensity of 140 lux and values ranging from 28.2 to 16.2 were obtained at the luminous intensity of 180 lux. On the other hand, in Comparative Examples 1 to 4, the value of the term “LU20−LU5” ranging from 12.1 to 68.2 was obtained at the luminous intensity of 140 lux and values ranging from 6.6 to 17.5 were obtained at the luminous intensity of 180 lux.

What is claimed is:

1. A resin composition for a cover or topcoat of a golf ball, the resin composition comprising:
a resin for a cover or topcoat of a golf ball;
an ultraviolet (UV) absorber for absorbing UV rays, of which an absorbance spectrum has an absorption peak at a wavelength in a range of 310 nm to 330 nm, has an absorbance in a wavelength range of 300 nm to 350 nm of at least 1.0 AU and has an absorbance at a wavelength of 370 nm of 0.1 to 0.5 AU; and
a fluorescent whitening agent for absorbing UV rays and emitting visible rays, of which an absorbance spectrum has an absorption peak at a wavelength in a range of 350 nm to 370 nm,
wherein a concentration of the UV absorber ranges from 0.25 to 1.5% by mass with respect to a total mass of the resin composition.

2. The resin composition according to claim 1, wherein in the absorption spectrum of the UV absorber, an area obtained by integrating absorbance over a wavelength range from 290 nm to 320 nm is substantially equal to an area obtained by integrating absorbance over a wavelength range from 320 nm to 350 nm, and the area is twice as large as an area obtained by integrating absorbance over a wavelength range from 350 nm to 390 nm.

3. The resin composition according to claim 1, wherein the concentration of the UV absorber ranges from 0.4 to 0.5% by mass with respect to the total mass of the resin composition.

4. The resin composition according to claim 1, wherein the resin composition has a luminance characteristic satisfying the following expression:
LU20−LU5≧20 cd/m²
where LU5 denotes a luminance obtained by irradiating a film having a thickness of 5 μm formed from the resin composition with UV rays having a luminous intensity of 140 lux, and LU20 denotes a luminance obtained by irradiating a film having a thickness of 20 μm formed from the resin composition with UV rays having a luminous intensity of 140 lux.

5. The resin composition according to claim 1, wherein the resin composition has a color difference ΔEh in a Lab color system between before and after a color tone change test of at most 2.5, the color tone change test being carried out by irradiating a film formed from the resin composition with a xenon lamp.

6. The resin composition according to claim 1, wherein the resin composition has a change in yellowness index ΔYI between before and after a color tone change test of at most 10, the color tone change test being carried out by irradiating a film formed from the resin composition with a xenon lamp.

7. A resin composition for a cover or topcoat of a golf ball, the resin composition comprising:
a resin for a cover or topcoat of a golf ball;
an ultraviolet (UV) absorber for absorbing UV rays, of which an absorbance spectrum has an absorption peak at a wavelength in a range of 310 nm to 330 nm, has an absorbance in a wavelength range of 300 nm to 350 nm of at least 1.0 AU and has an absorbance at a wavelength of 370 nm of 0.1 to 0.5 AU; and
a fluorescent whitening agent for absorbing UV rays and emitting visible rays, of which an absorbance spectrum has an absorption peak at a wavelength range of 350 nm to 370 nm,
wherein the resin composition has a luminance characteristic satisfying the following expression:
LU20−LU5≧20 cd/m²
where LU5 denotes a luminance obtained by irradiating a film having a thickness of 5 μm formed from the resin composition with UV rays having a luminous intensity of 140 lux, and LU20 denotes a luminance obtained by irradiating a film having a thickness of 20 μm formed from the resin composition with UV rays having a luminous intensity of 140 lux,
wherein the resin composition has a color difference ΔEh in a Lab color system between before and after a color tone change test of at most 2.5, the color tone change test being carried out by irradiating a film formed from the resin composition with a xenon lamp.

8. A golf ball comprising a core, a cover, and a topcoat,
wherein the cover or the topcoat comprises a UV absorber for absorbing UV rays and a fluorescent whitening agent for absorbing UV rays and emitting visible rays,
wherein an absorbance spectrum of the UV absorber has an absorption peak at a wavelength in a range of 310 nm to 330 nm, has an absorbance in a wavelength range of 300 nm to 350 nm of at least 1.0 AU and has an absorbance at a wavelength of 370 nm of 0.1 to 0.5 AU,
wherein an absorbance spectrum of the fluorescent whitening agent has an absorption peak at a wavelength in a range of 350 nm to 370 nm, and
wherein a concentration of the UV absorber ranges from 0.25 to 1.5% by mass with respect to a total mass of the cover or the topcoat.
